(19) United States
(12) Patent Application Publication
(10) Pub. No.: US 2006/0147875 A1
(43) Pub. Date: Jul. 6, 2006

(54) Electric wax chisel

(76) Inventor: Jae-Wan Ahn, Daegu (KR)

Correspondence Address: Klaus P Stoffel;Wolff & Samson, One Boland Drive, West Orange, NJ, 07052, US

(21) Appl. No.: 10/561,719

(22) PCT Filed: Jun. 26, 2004
(86) PCT No.: PCT/KR04/01565

§ 371 Date: Dec. 22, 2005

(30) Foreign Application Priority Data
Jun. 26, 2003 (KR) 10-2003-0042244

(51) Int. Cl. A61C 3/00; B67D 5/62

(52) U.S. Cl. 433/32; 222/146.5

(57) ABSTRACT

Disclosed is an electric wax chisel. A main body having a shape of hollow cylinder includes a tank provided inside the hollow cylinder. The tank contains wax. A chisel tip having a hole is installed at one end of the main body. A heating member is disposed in the outer face of the tank. A control box is electrically connected with the main body by an electric wire. The main body comprises a first chamber and a second chamber. The first chamber has an exit hole at one end, in which the chisel tip is mounted, and an inlet hole at the other end. The second chamber has a discharging hole correspond to the inlet hole, and a tank to contain a wax. A terminal for supplying an electric power is disposed in the second chamber. A cap for sealing the second chamber is provided. The cap has a space depressed inwardly along the tube axis. Therefore, the electric wax chisel is improved so as to use easily and conveniently.

### TECHNICAL FIELD

The present invention relates to an electric wax chisel, particularly, to an electric wax chisel, in which the structure thereof is improved, thereby enabling to use easily and conveniently the electric wax chisel.

### BACKGROUND ART

As well known, an electric wax chisel is used, for example, for covering a wax over a tooth mould when a mould of tooth shape is fabricated.

Many types of such electric wax chisel have already been proposed. In general, a chisel tip is heated using the heat of an alcohol lamp, and a wax is melted by the heated chisel tip. The molten wax is covered over the work piece.

In the above conventional method, however, the heated chisel tip is readily cooled, and therefore, the chisel tip must be frequently re-heated while using it. Consequently, a significant problem in the conventional method is a decreased efficiency.

As another conventional method, a heater is attached to the chisel in order to melt the wax. In this technique, however, the heater is installed over the entire length of the main body of the chisel, and an electric power is continuously supplied to generate heat. This method also has many problems and disadvantages in that the electric power is unnecessarily wasted, the handle of the chisel is heated up together when in use, the amount of wax cannot be controlled, and the wax discharging hole is often blocked by a foreign material, or the like.

### DISCLOSURE OF INVENTION

Therefore, the present invention has been made in order to solve the above problems in the prior art, and it is an object of the present invention to provide an electric wax chisel, in which the structure thereof is improved, thereby enabling to use easily and conveniently the electric wax chisel.

In order to accomplish the above object, according to one aspect of the invention, there is provided an electric wax chisel of a first embodiment. The electric wax chisel. according to the first embodiment of the invention comprises: a) a main body having a shape of hollow cylinder and including a tank provided inside of the main body, the tank being capable of containing a wax, the main body being electrically connected by an electric wire; b) a chisel tip having a hole, the chisel top being installed at one end of the main body; and c) a heating member being heated by a power supply; d) wherein the main body comprises a plurality of chambers, which are detachably attached to each other, a chisel tip connection portion formed in at least one chamber, and a tube member forming a tube passageway and connecting the tank and the chisel tip connection portion.

As a construction in order to effectively practice the first embodiment, the main body comprises: a) a first chamber having a tube member, an exit bole being formed at one end of the tube member and an inlet hole being formed at the other end of the tube member, the exit hole being connected with the tip connection portion; and b) a second chamber having a discharging hole to be connected with the inlet hole of the first chamber, a tank to contain a wax being provided inside thereof.

As another construction in order to effectively practice the first embodiment, the heating member is disposed either at the side of the exit hole of the first chamber, or at the side of the discharging hole in the second chamber.

As another construction in order to effectively practice the first embodiment, a filter is disposed selectively at least one of at the exit hole, at the inlet hole, in the tube passageway of the discharging hole, and at a bottom portion of the tank, thereby filtering undesired materials contained in the wax.

As another construction in order to effectively practice the first embodiment, a valve is provided in the tube passageway between the exit hole and the inlet hole in order to selectively open or close the tube passageway by means of the operation of an operating button.

As another construction in order to effectively practice the first embodiment, the valve includes a solenoid valve electrically connected with the operating button.

As another construction in order to effectively practice the first embodiment, a second valve is further provided at least one of at the inlet hole and at the discharging hole in order to prevent the molten wax from releasing through the inlet hole or the discharging hole when the first and second chambers are disassembled.

As another construction in order to effectively practice the first embodiment, the second valve comprises: a) at least two projections formed in the inner face of the discharging hole along the inner circumference thereof; b) a resilient member disposed at the side of the discharging hole towards of the projections and the inlet holes; and c) an operating member having at one side a flange supported by the resilient member and at the other side an operating pin extending from the center of the flange toward the inlet hole along. the axis of the tube member, wherein the operating pin is extended into the inlet hole and one end portion thereof is supported by the filter.

As another construction in order to effectively practice the first embodiment, the first chamber is provided with a temperature-sensing device for sensing the temperature of the heating member and intermitting the power supply.

According to another aspect of the invention, there is provided an electric wax chisel of a second embodiment. The electric wax chisel according to the second embodiment of the invention comprises: a) a main body having a shape of hollow cylinder and a tank provided inside the hollow cylinder, the tank being capable of containing a wax; b) a chisel tip mounted at one end portion of the main body; and c) a heating member heated by a power supply, the heating member being electrically connected by an electric wire of the electric wax chisel; d) wherein a chisel tip connection portion is integrally formed with the main body, the tank is mounted inside the integral main body, a tube member constituting a tube passageway and connecting the chisel tip connection portion and the tank.

As a construction in order to effectively practice the second embodiment, the heating member is selectively disposed at least at one position along the length of the tube member.

As another construction in order to effectively practice the second embodiment, the heating member is disposed in the tank side and chisel tip side respectively of the tube member.

As another construction in order to effectively practice the second embodiment, a filter for filtering undesired materials contained in the wax is provided at least one of at the tube member, at one side of the exit hole, and at the bottom portion of the tank.

As another construction in order to effectively practice the second embodiment, the tube member is provided with a valve for selectively opening or closing the tube passageway by operation of the operating button.

As another construction in order to effectively practice the second embodiment, the valve includes a solenoid valve electrically connected with the operating button.

As another construction in order to effectively practice the second embodiment, a temperature-sensing device is provided near the exit hole in the tube passageway of the tube member in order to sense the temperature and intermit the power supply.

According to another aspect of the invention, there is provided an electric wax chisel of a third embodiment. The electric wax chisel according to the third embodiment of the invention comprises: a) a main body having a shape of hollow cylinder and a tank provided inside the hollow cylinder, the tank being capable of containing a wax; b) a chisel tip mounted at one end portion of the main body; and c) a heating member heated by a power supply, the heating member being electrically connected by an electric wire of the electric wax chisel; d) wherein an operating button is provided at the outer face of the main body, a control unit to be controlled by the operating button is provided at the inner face of the main body, and a solenoid valve is mounted between the chisel tip and the tank such that one side thereof forms a tube passageway with the chisel tip and other side thereof forms a tube passageway with the exit hole of the tank and the solenoid valve is controlled by the control of the control unit according to the operation of the operating button.

As a construction in order to effectively practice the third embodiment, the main body is provided with a cap at the other end thereof, the cap having an air control valve, and the tank is able to be disassembled together with the cap.

As another construction in order to effectively practice the third embodiment, the tank is able to be disassembled from the cap and the solenoid valve at one end and the other end thereof respectively, a filter for filtering undesired materials is disposed at the other end, i.e., at the exit hole side, and a consumable wax for a single use is contained inside the tank.

As another construction in order to effectively practice the third embodiment, the heating member is disposed at least one of in the chisel tip, in the solenoid valve, and at the exit hole side of the tank.

### BRIEF DESCRIPTION OF DRAWINGS

Further objects and advantages of the invention can be more fully understood from the following detailed description taken in conjunction with the accompanying drawings in which:

FIG. 1 is an exploded perspective view of an electric wax chisel according to a first embodiment of the invention;

FIG. 2 illustrates a general overview of an electric wax chisel according to the invention;

FIG. 3 is an enlarged view showing a state of installed filter;

FIG. 4 is a perspective view of an assembled electric wax chisel according to the invention;

FIGS. 5A and 5B are enlarged cross-sectional views showing an operating state of the second valve according to the invention;

FIG. 6 is a block diagram showing a configuration of the control box according to the invention;

FIG. 7 is a general cross-sectional view of an electric wax chisel according to the first embodiment of the invention;

FIGS. 8 and 9 are cross-sectional views showing forms of wax to be used in the invention;

FIG. 10 is a cross-sectional view showing an electric wax chisel according to another embodiment of the invention;

FIG. 11 is a perspective view of an assembled state of the electric wax chisel in FIG. 10;

FIG. 12 is a cross-sectional view showing an electric wax chisel according to a third embodiment of the invention;

FIG. 13 is an exploded cross-sectional view showing the electric wax chisel in FIG. 12; and

FIG. 14 is another exploded cross-sectional view showing the electric wax chisel in FIG. 12.

### BEST MODE FOR CARRYING OUT THE INVENTION

Referring to the accompanying drawings, the preferred embodiments according to the present invention are hereafter described in detail.

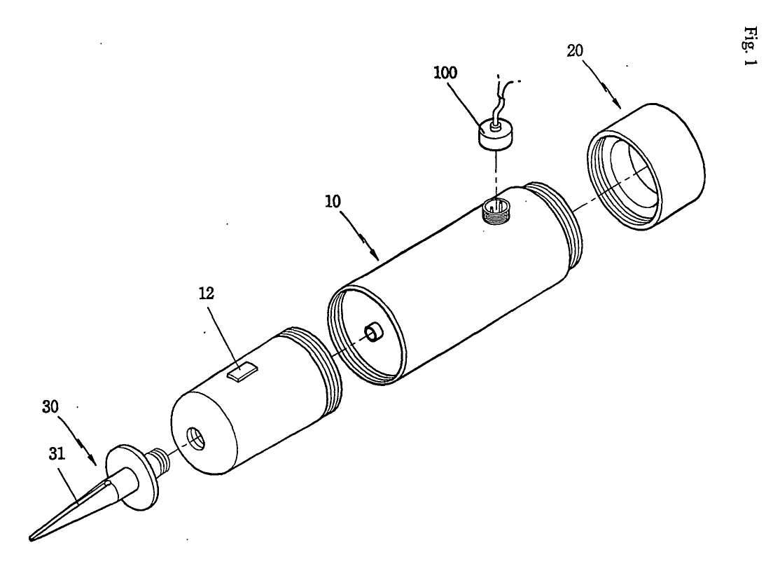

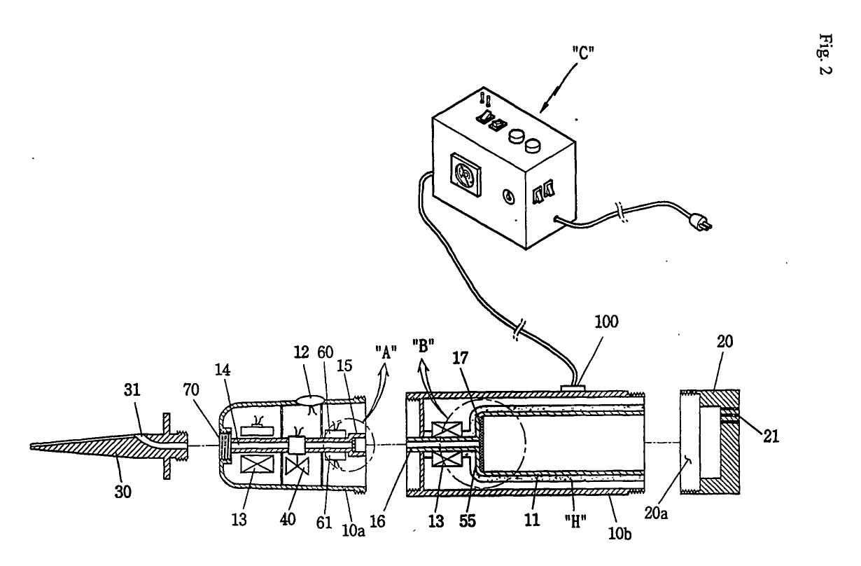

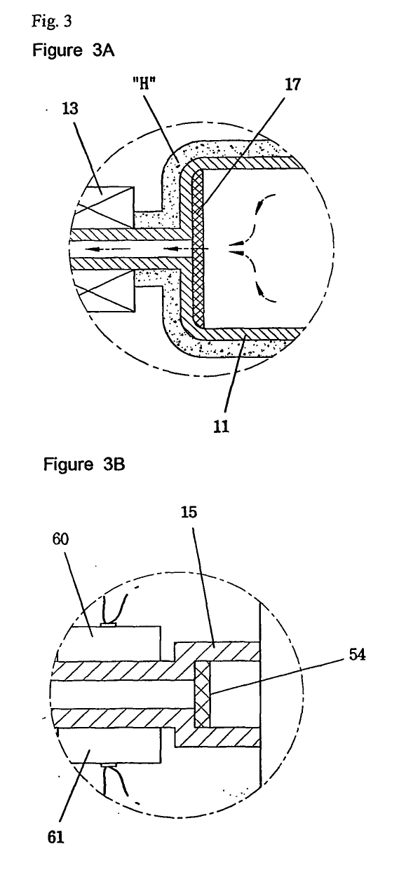

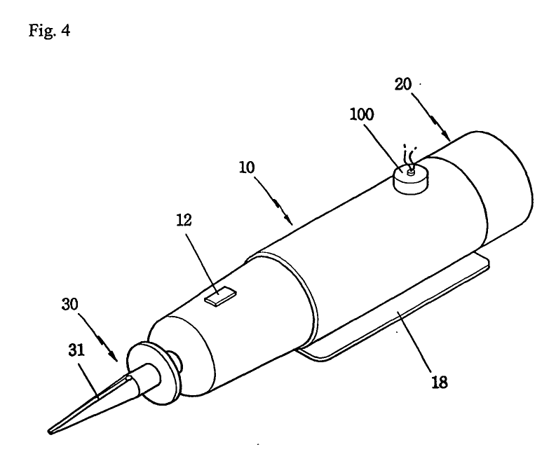

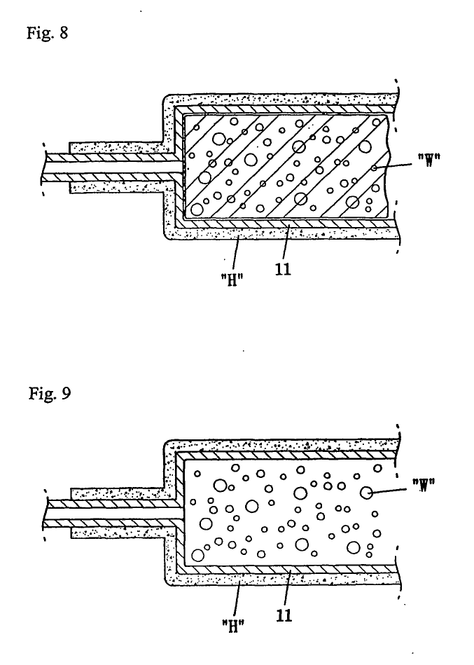

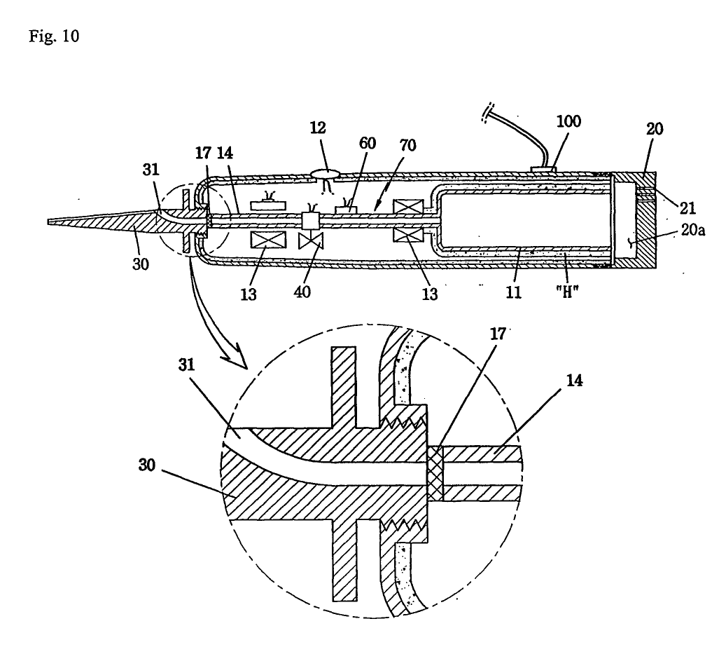

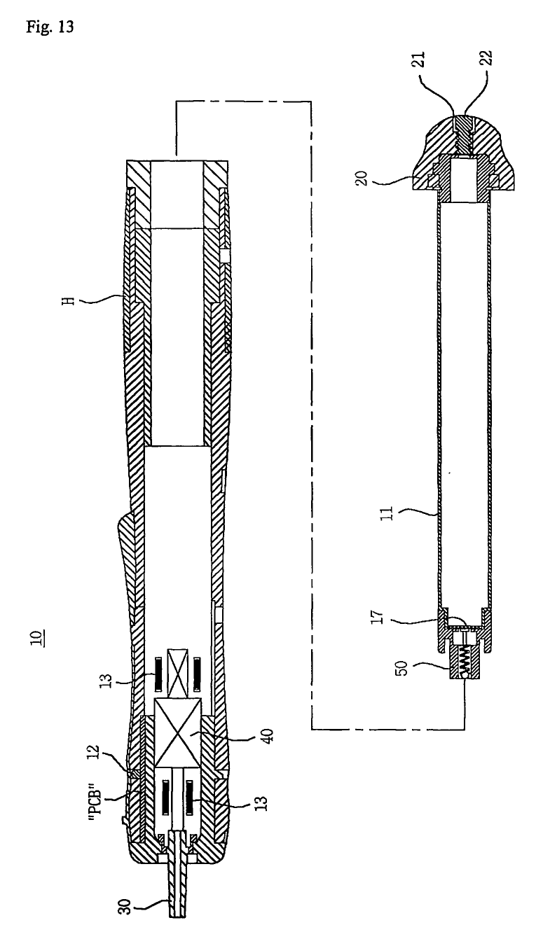

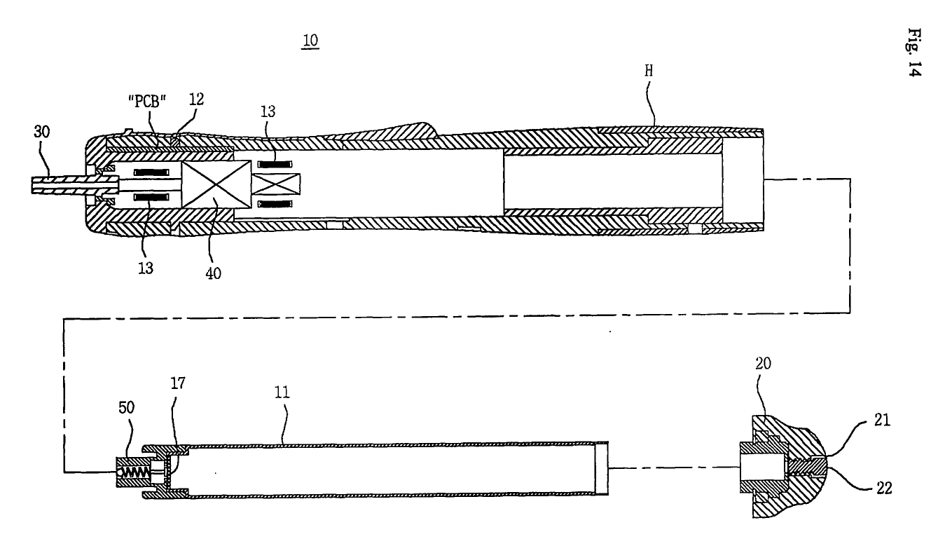

FIGS. 1 and 2 are an exploded perspective view and a cross-sectional view of an electric wax chisel according to one embodiment of the invention. FIGS. 3 to 9 illustrate another embodiments of the electric wax chisel of the invention, and FIGS. 10 to 14 show cross-sectional and perspective views of further embodiments of the electric wax chisel of the invention.

In all the embodiments of the invention, identical components of each embodiment are not repeated in the figures illustrating the respective embodiment.

As shown in the figures, te electric wax chisel of the invention comprises a main body 10 having the form of a hollow cylinder. The main body 10 is provided with a tank 11 thereinside, in which a wax W can be contained, and is provided with a cap for sealing it.

The main body 10 is provided with a chisel tip 30 at one end of the main body 10, and a hole 31 is formed in the chisel tip 30. In an appropriate position of the upper portion of the main body 10 is installed an operating button 12 for a valve and a heating member or the like, which will be hereafter described in detail.

In addition, a heating member 13 is disposed in the outer peripheral surface of the tank 11. The main body 10 is connected with a control box C by an electric wire. This construction is similar to that of an electric wax chisel, which is disclosed in one of previous patent applications filed by the present applicant.

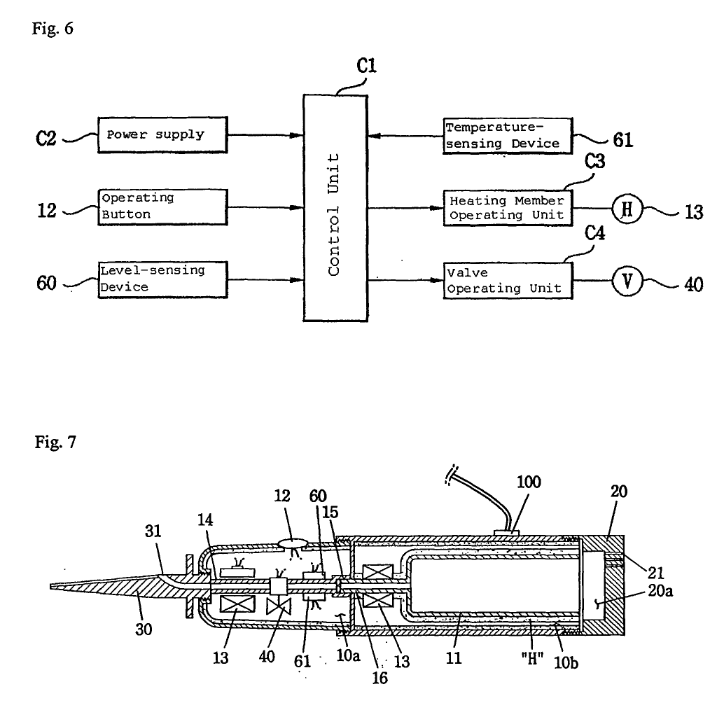

On the other hand, the control box C includes a control unit C1, a power supply C2, a heating member operator C3, and a valve operator C4, as shown in FIG. 6.

The major features of the electric wax chisel according to a first embodiment of the invention are explained below. The main body 10 comprises a first chamber 10a and a second chamber 10b. At one end portion of the first chamber 10a is formed an exit hole 14, to which the chisel tip 30 is mounted. At the other end portion thereof is formed an inlet hole 15. The second chamber 10b is provided with a discharging hole 16 formed in the position corresponding to the inlet hole 15 of the first chamber 10a. Also, the second chamber 10b includes the tank 11 capable of containing wax, and a connector 100, through which an electric power is supplied to the electric wax chisel of the invention.

In the above construction, the inlet hole 15 and the exit hole 14 of the first chamber 10a, and the discharging hole 16 of the second chamber 10b may be integrally formed with the main body 10 by means of an injection molding process. Alternatively, they may be fabricated separately such that they can be connected air-tightly with each other.

However, the inlet hole 15 and the discharging hole 16 are preferred to be structured such that one of them can be tightly inserted into the other so as to maintain its air-tightness. More preferably, a packing ring or a sealing member is installed in the engaging portion of the inlet hole 15 and the discharging hole 16 in order to provide an air-tightness thereto.

Furthermore, in case where a separate tube member constituting the inlet hole 15 and the discharging hole 14 is fabricated, a lib may be provided with the tube member formed in a radial direction on the peripheral face thereof. The inlet hole 15 and the discharging hole 14 can be attached or fixed to the inner surface of the first chamber 10a.

In addition, the cap 20 sealing the second chamber 10b has a space formed inward the cap 20, and a ventilating hole 21 communicating with the second chamber 10b is formed in the cap 20.

The structure of the ventilating hole 21 is preferably configured such that the inward inner diameter of the cap 20 is smaller than the outward inner diameter thereof, thereby preventing a melted wax from flowing outside the electric wax chisel of the invention. More preferably, the ventilating hole 21 may be formed in the upper portion of the circumference of the cap 20 when the main body 10 rests horizontally.

In addition, the ventilating hole 21 may be formed vertically and fluid-communicatively from the top thereof inwards of the cap 20.

Alternatively, a valve 40 may be provided in the tank 11 and the cap 20 in order to control the air suction so that the wax contained in the tank 11 can be flown out therefrom.

According to the invention, the heating member 13 may be disposed selectively in the exit hole 14 of the first chamber 10a or in the discharging hole 16 of the second chamber 10b, or both of them.

Preferably, at least one of the exit hole 14, the inlet hole 15, and the discharging hole 16 may be provided with a filter in the passageway thereof in order to filter undesired materials contained in the molten wax.

The tank 11 or the main body 10 is preferably provided with an insulation member H in the inner side thereof.

In addition, between the exit hole 14 and the inlet hole 15 is provided a valve 40 in their passageway so as to selectively open and close the passageway thereof by the operation of the operation button 12.

The valve 40 is preferred to be a solenoid valve electrically connected with the operating button 12, but not limited thereto. For example, the valve 40 can be operated mechanically. A tube can be installed instead of the operating button 12, such that the molten wax can be discharged by the air pressure exerted by the operation of the tube.

In addition, the connector 100 may be configured such that an electric wire connected to the main body can be disconnected when required.

On the other hand, the main body is provided with a flat portion 18 formed at a portion of the outer circumference thereof in order for the electric wax chisel not to roll down when it rests on a slanted place.

Preferably, at least one of the inlet hole 15 and the discharging hole 16 is provided with a second valve 50 for preventing the molten wax from flowing out through the inlet hole 16 or the discharging hole 16 when the first and second 10) chambers 10a, 10b of the main body 10 are disconnected from each other.

The second valve 50 includes at least two projections 51 formed in the inner circumferential face of the second chamber 10b along the inner circumference thereof, a resilient member 52 supported by the projections 51 and disposed in the discharging hole side, and an operating member 53 including a flange 53a and an operating pin 53b fixed to the flange 53a. The flange 53a of the operating member 53 is supported by the resilient member 52 and biased toward the discharging hole 16 by the resilient member 52. The operating pin 53b is extended through the discharging hole 16 towards the inlet hole 15. A supporting member 54 is provided between the inlet hole 15 and the discharging hole 16 to support the front end of the operating pin 53b and also serve as a filter.

The end portion of the second chamber 10b constitutes a rim 55, which has a diameter larger than that of the discharging hole 16 so as to prevent the operating member 53 from escaping. from the second chamber 10b.

Preferably, the first chamber 10a includes a level sensing device 60 provided in the side of the inlet hole 15. The level sensor 60 senses the inclination of the main body 10 in the state of non-operation thereof, and closes the inlet hole 15 by operating the valve 40, or stops the operation of the control box C.

For the above purpose, the level sensing device 60 is preferred to include a balance sensor. The balance sensor may use a combination of a slanted surface and a ball, or a device for sensing a level by means of a bubble. Other various level-sensing devices can be applied to the present invention.

As another embodiment of the level sensing device 60, a temperature-sensing device 61 may be provided at the side of the inlet hole 15 of the first chamber 10a. The temperature sensing device 61 senses the temperature of the heating member 13 and closes the inlet hole 15 by operating the valve 40, or stops the operation of the control box C.

The temperature-sensing device 61 is preferred to be a temperature sensor such as a thermistor.

As shown in FIG. 6, the power supply C supplies a normal alternating electric power and a required direct current converter, the operating button 12 generates an operation command for the valve, and the level-sensing device includes a balance sensor for transmitting a balance sensing signal to the control unit C1.

The temperature-sensing device 61 includes a temperature sensor such as a thermistor for transmitting a temperature-sensing signal to the control unit C1.

The heating-member operating unit C3 controls an electric power supplied to the heating member 13 according to the control of the control unit C1, and the valve operating unit C4 opens and closes the valve 40 according to the control of the control unit C1.

When the temperature value received from the temperature-sensing device 61 is higher than a reference value, the control unit C1 stops the operation of the heating member 13 by controlling the heating member operating unit C4.

When an unbalance signal is received from the level-sensing device 60 at the pressed state of the operating button 12, the control unit C1 control the valve operating unit C4 so as to open the valve 40.

On the other hand, when an unbalance signal is received from the level-sensing device 60 at the unpressed state of the operating button 12, i.e., at the non-operation state, the control unit C1 controls the valve operating unit C4 so as to close the valve 40, thereby avoiding the flowing-out of the molten wax.

In addition, the wax W used in the invention may have a rod-like shape, or a form of granules or particles.

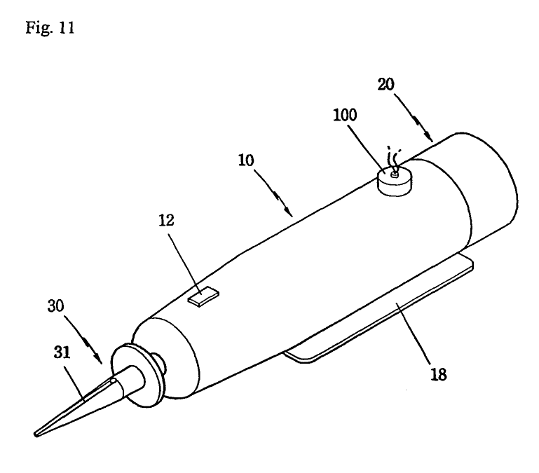

In the embodiment of the invention as described above, the main body 10 is composed of a first and second chambers 10a, 10b, a chisel tip 30 disposed at one end of the main body 10, and a cap 20 installed at the other end of the main body 10. Dissimilar to the previous embodiment, in another embodiment as shown in FIGS. 10 and 11, the main body 10 is formed in an integral single piece, the chisel tip 30 is detachably attached to one end of the main body 10, and the cap 20 is provided at the other end of the main body 10.

The heating member 13 may be disposed selectively at least at one position along the length of the tube member.

Alternatively, the heating member 13 can be installed at the tank side and the chisel tip side respectively of the tube member.

Preferably, in order to filter undesired materials contained in the wax, a filter 17 is installed at least one of at the tube member, at a certain position of the exit hole, and at the bottom portion of the tank.

The valve 40 is preferably disposed in the passageway of the tube member so as to selectively open or close the passageway by the operation of the operating button. The valve 40 is preferred to be a solenoid valve electrically connected with the operating button.

On the other hand, a level-sensing device 60 is provided near the exit hole 14 of the passageway of the tube member for sensing the inclination of the main body and, according to the sensing result, closing the passageway of the tube member or controlling the electric power being supplied. The level-sensing device 60 is preferred to be a balance sensor.

A temperature-sensing device is preferably provided near the exit hole in the passageway of the tube member for sensing the temperature and intermitting the supply of electric power when required.

The operation of the electric wax chisel according to the present embodiment will be explained below. The operation of other embodiments is identical and thus will not be described here.

The components shown in FIGS. 1 and 2 will be assembled into the electric wax chisel of the invention.

A wax having a rod-like shape or a granular form is filled inside the tank 11. The electrical source of the control box C is electrically connected to a commercial power supply so as to supply the electric power continuously.

On the other hand, at the above state, i.e., at the state that the first and second chambers 10a, 10b are assembled, the front end of the operating pin 53b of the operating member 53 provided in the second chamber 10b is supported by the supporting member 54 (also a filter) provided inward of the inlet hole 15, and therefore, the flange 53a of the operating member 53 overcomes the spring force of the resilient member 52 to form a flow passage.

From the initial state of the electric wax chisel, a user grips the main body 10 and uses the electric wax chisel by using the molten wax flowing out from the tank 11 through the hole 31 formed in the chisel tip 30, as described in the previous patent application filed by the present applicant.

More specifically, during the operation, the heating member maintains an appropriate temperature of the chisel tip and inside the electric wax chisel by using the supplied electric power. When the operating button is operated, the valve is open and the molten wax is flown out.

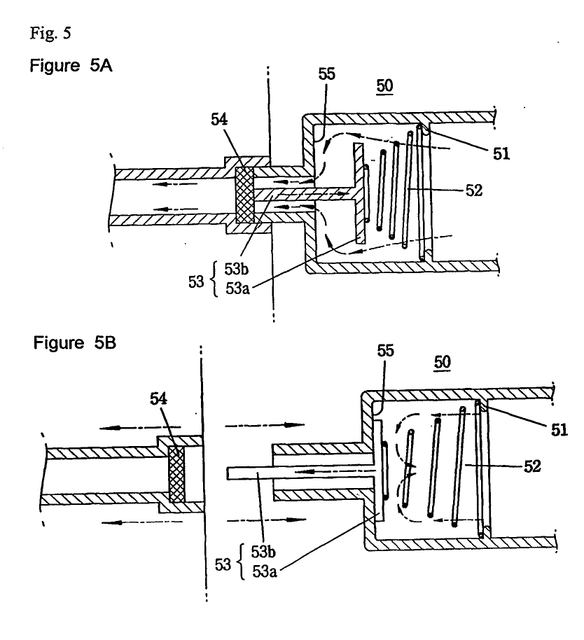

Therefore, the wax W contained in the tank 11 is melted after a certain period of time. Then, as marked by an arrow in FIG. 5A, the molten wax is flown out through the hole 31 formed in the chisel tip 30 via the discharging hole 16, the inlet hole 15, the opened valve 40 and the exit hole 14.

Therefore, the user can carry out a tooth molding, or the like by using the molten wax being flown out through the hole 31.

On the other hand, the operation of major components is explained. The power supply C2 provided inside the control box C supplies a normal alternating current and a required direct voltage, and thus the heating member is heated up when necessary. The operating button 12 generates an operation command for the valve, and the level-sensing device 60 senses the balance state of the main body 10.

Further, the temperature-sensing device 61 including a temperature sensor such as a thermistor senses whether the temperature of the heating member 13 is raised higher than a set temperature value, and transmits the sensed temperature signal to the control unit C1.

At the above-described state, the heating member operating unit C3 controls the electric power supplied to the heating member 13 according to the control of the control unit C1. The valve operating unit C4 opens the valve 40 to release the molten wax according to the control of the control unit C1.

On the other hand, when the temperature sensing value received from the temperature-sensing device 61 is higher than the set reference value, the control unit C1 controls the heat member operating unit C3 to stop the operation of the heating member 13. At the pressed state of the operating button, when a unbalance signal is received from the level-sensing device 60, the control unit C1 controls the valve operating unit C4 so as not to close the valve 40, thereby enabling the use of the main body 10 at the slanted state thereof.

On the contrary, at the unpressed state of the operating button, i.e., at the non-operating state, when a unbalance signal is received from the level-sensing device 60, the control unit C1 controls the valve operating unit C4 so as to close the valve 40, thereby preventing the molten wax from flowing out through the tube passageway.

On the other hand, since the molten wax communicates with the ambient atmosphere through the ventilating hole 21 formed in the cap 20, the molten wax can continue flowing-out without any external force.

More preferably, an additional valve for controlling the opening and closing of the ventilating hole 21 can be provided in order to control the amount of molten wax being released.

For example, while not using the electric wax chisel, it can be placed on the flat surface of the working space such that the flat portion 18 of the main body 10 is contacted with the flat surface, thereby maintaining the horizontal state of the wax chisel. While the electric wax chisel of the invention rests on the flat place, the volume of the tank 11 is enlarged by the space 20 formed in the cap 20, thereby preventing the molten wax from flowing out through the ventilating hole 21.

On the other hand, when the wax chisel is not used at the state that the chisel tip 30 is oriented downwards, the level-sensing device 60 senses this state and sends an unbalance signal. Then, the control unit C1 controls the valve operating unit C4 so as to close the valve 40, thereby shutting down the flow of molten wax through the tube passageway.

When the first and second chamber 10a, 10b of the main body 10 are disassembled for an after-service or cleaning, as shown in FIG. 5B, the flange 53a of the operating member 53 is pushed toward the discharging hole 16 due to the restoring force of the. resilient member 52, and thus the inner face of the flange 53a closes the discharging hole 16, thereby preventing a leakage of the molten wax through the discharging hole 16.

The construction and operation of the second embodiment of the invention is identical to that of the first embodiment as described above, and will not be repeated here.

Instead of the electric valve in the above embodiment, a rubber tube may be used, and the amount of the molten wax to be discharged can be controlled by the air pressure of the rubber tube.

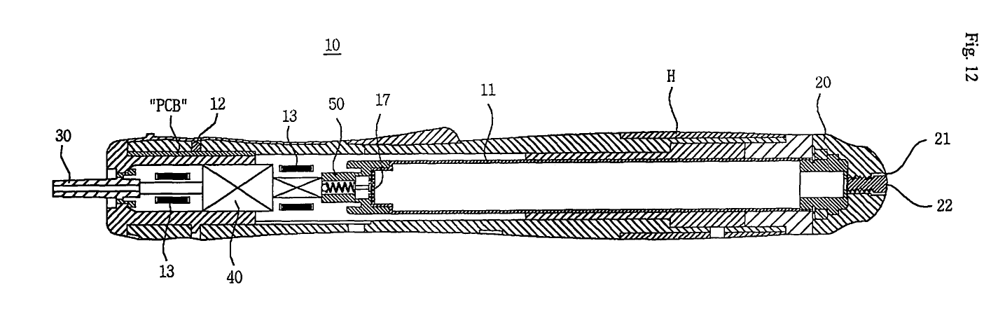

FIGS. 12 to 14 are cross-sectional views of an electric wax chisel according to a third embodiment of the invention.

As shown in FIGS. 12 to 14, the tank 11 is disposed at one side of the main body 11, at the other side of which a chisel tip 30 for discharging a molten wax is disposed, similarly to the first and second embodiments. Between the tank 11 and the chisel tip 30 is installed the solenoid valve 40 and the second valve 50 for selectively releasing the molten wax and also serving as a tube passageway.

In addition, an insulating member is provided along the outer circumference of the main body at the gripping portion by a user. Although not shown, . . . (omitted) supported by the internal structure of the tube member, not by the supporting member 54 (also a filter).

Here, the solenoid valve 40 and the second valve 50 is opened and closed by the operation of the control unit C1 including a PCB, which is controlled by the operation of an operating button 12 provided in the outside of the main body 10.

The major feature of the third embodiment is in that the tank 11 to contain a wax. can be disassembled together with the cap from the main body 10 to refill the wax, or the tank 11 without the cap 20 can be fabricated as a consumable tank for a single use.

At this time, the second valve 50 attached to the tank 11 is disassembled from the solenoid valve 40, simultaneously the second valve 50 shuts down the flow of the molten wax.

In addition, the cap 20 is provided with an air control valve 22 for adjusting the gap of the ventilating hole 21 so that the atmospheric pressure can be exerted into the inside of the tank 11, thereby enabling the control of the flow rate of the molten wax.

For the more effective air control, a check valve for allowing for one-way flow may be provided at the engaging portion of the tank 11 with the air control valve 22, although now shown in the drawings.

A further feature of the third embodiment is in that the solenoid valve 40 and the second valve 50 are detachably installed between the tank 11 and the chisel tip 30 such that they can serve as a tube passageway and control the flow of molten wax from the tank 11.

The solenoid valve 70 and the second valve 50 are operated by the operation of the operating button 12 and the control of the control unit C1.

The above-described third embodiment has a simple internal structure, relative to the previous first and second embodiments. That is, the front-end portion of the main body 10 having the chisel tip 30 attached thereto may be constructed to be detachable from the main body 10. Alternatively, the main body 10 may be formed in a single integral form, except for the cap 20.

### INDUSTRIAL APPLICABILITY

As described above, the electric wax chisel according to the invention has improved its structure such that it can be easily and conveniently used as a wax chisel.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An electric wax chisel comprising:
a) a main body having a shape of hollow cylinder and including a tank provided inside of the main body, the tank being capable of containing a wax, the main body being electrically connected by an electric wire;
b) a chisel tip having a hole, the chisel top being installed at one end of the main body; and
c) a heating member being heated by a power supply;
d) wherein the main body includes a plurality of chambers, which are detachably attached to each other, a chisel tip connection portion formed in at least one chamber, and a tube member forming a tube passageway and connecting the tank and the chisel tip connection portion.

2. An electric wax chisel according to claim 1, wherein the main body comprises: a) a first chamber having a tube member, an exit hole being formed at one end of the tube member and an inlet hole being formed at the other end of the tube member, the exit hole being connected with the tip connection portion; and b) a second chamber having a discharging hole to be connected with the inlet hole of the first chamber, a tank to contain a wax being provided inside thereof.

3. An electric wax chisel according to claim 2, wherein the heating member is disposed either at the side of the exit hole of the first chamber, or at the side of the discharging hole in the second chamber.

4. An electric wax chisel according to claim 2, wherein a filter is disposed selectively at least one of at the exit hole, at the inlet hole, in the tube passageway of the discharging hole, and at a bottom portion of the tank, thereby filtering undesired materials contained in the wax.

5. An electric wax chisel according to claim 2, wherein a valve is provided in the tube passageway between the exit hole and the inlet hole in order to selectively open or close the tube passageway by means of the operation of the operating button.

6. An electric wax chisel according to claim 5, wherein the valve includes a solenoid valve electrically connected with the operating button.

7. An electric wax chisel according to claim 2, wherein a second valve is further provided in at least one of the inlet hole and the discharging hole in order to prevent the molten wax from releasing through the inlet hole or the discharging hole when the first and second chambers are disassembled.

8. An electric wax chisel according to claim 7, wherein the second valve comprises: a) at least two projections formed in the inner face of the discharging hole along the inner circumference thereof; b) a resilient member disposed at the side of the discharging hole towards of the projections and the inlet holes; and c) an operating member having at one side a flange supported by the resilient member and at the other side an operating pin extending from the center of the flange toward the inlet hole along the axis of the tube member, wherein the operating pin is extended into the inlet hole and one end portion thereof is supported by the filter.

9. An electric wax chisel according to claim 2, wherein the first chamber is provided with a temperature-sensing device for sensing the temperature of the heating member and intermitting the power supply.

10. An electric wax chisel comprising:
a) a main body having a shape of hollow cylinder and a tank provided inside the hollow cylinder, the tank being capable of containing a wax;
b) a chisel tip mounted at one end portion of the main body; and
c) a heating member heated by a power supply, the heating member being electrically connected by an electric wire of the electric wax chisel;
d) wherein a chisel tip connection portion is integrally formed with the main body, the tank is mounted inside the integral main body, a tube member constituting a tube passageway and connecting the chisel tip connection portion and the tank.

11. An electric wax chisel according to claim 10, wherein the heating member is selectively disposed at least at one position along the length of the tube member.

12. An electric wax chisel according to claim 10, wherein the heating member is disposed in the tank side and chisel tip side respectively of the tube member.

13. An electric wax chisel according to claim 10, wherein a filter for filtering undesired materials contained in the wax is provided at least one of at the tube member, at one side of the exit hole, and at the bottom portion of the tank.

14. An electric wax chisel according to claim 10, wherein the tube member is provided with a valve for selectively opening or closing the tube passageway by operation of the operating button.

15. An electric wax chisel according to claim 10, wherein the valve includes a solenoid valve electrically connected with the operating button.

16. An electric wax chisel according to claim 10, wherein a temperature-sensing device is provided near the exit hole in the tube passageway of the tube member in order to sense the temperature and intermit the power supply.

17. An electric wax chisel comprising:
a) a main body having a shape of hollow cylinder and a tank provided inside the hollow cylinder, the tank being capable of containing a wax;
b) a chisel tip mounted at one end portion of the main body; and
c) a heating member heated by a power supply, the heating member being electrically connected by an electric wire of the electric wax chisel;
d) wherein an operating button is provided at the outer face of the main body, a control unit to be controlled by the operating button is provided at the inner face of the main body, and a solenoid valve is mounted between the chisel tip and the tank such that one side thereof forms a tube passageway with the chisel tip and other side thereof forms a tube passageway with the exit hole of the tank and the solenoid valve is controlled by the control of the control unit according to the operation of the operating button.

18. An electric wax chisel according to claim 17, wherein the main body is provided with a cap at the other end thereof, the cap having an air control valve, and the tank is able to be disassembled together with the cap.

19. An electric wax chisel according to claim 18, wherein the tank is able to be disassembled from the cap and the solenoid valve at one end and the other end thereof respectively, a filter for filtering undesired materials is disposed at the other end, i.e., at the exit hole side, and a consumable wax for a single use is contained inside the tank.

20. An electric wax chisel according to claim 17, wherein the heating member is disposed at least one of in the chisel tip, in the solenoid valve, and at the exit hole side of the tank.
